(19) United States
(12) Patent Application Publication
(10) Pub. No.: US 2004/0003317 A1
(43) Pub. Date: Jan. 1, 2004

(54) Method and apparatus for implementing fault detection and correction in a computer system that requires high reliability and system manageability

(76) Inventors: Atul Kwatra, Chandler, AZ (US); John P. Lee, Tempe, AZ (US); Aniruddha P. Joshi, Chandler, AZ (US)

Correspondence Address: KENYON & KENYON, Suite 600, 333 W. San Carlos, Street, San Jose, CA, 95110-2711, US

(21) Appl. No.: 10/180,452

(22) Filed: Jun. 27, 2002

(51) Int. Cl. H04L 1/22

(52) U.S. Cl. 714/25

(57) ABSTRACT

Embodiments of the present invention provide a method and apparatus for implementing fault detection and correction in a computer network. In one embodiment, the invention may provides a multi-stage watch-dog timer to monitor device operation in a computer system. A system bus controller may receive data related to a computer system fault from the multi-stage watch-dog timer and may log the fault data in memory. The system bus controller may also forward the fault data to an external server. In an alternative embodiment, the invention provides a processor that may re-set the multi-stage watch-dog timer at pre-determined intervals during normal operation. In yet another alternative embodiment, the processor may receive an interrupt from the watch-dog timer if at least one stage of the multi-stage watch-dog timer is not re-set during the fault and the processor may further run a diagnostic test to find the fault.

### TECHNICAL FIELD

The present invention relates to computer systems. In particular, the present invention provides fault detection and system management in a computer network.

### BACKGROUND OF THE INVENTION

In order to provide high availability and system manageability, it is important to monitor client/server operation in a computer system. A client is typically a computer workstation that is connected to a local area network (LAN) or Internet, for example. Typically, a client may use resources of another computer known as a server. The server is also connected to the LAN and may be shared among more than one client.

A typical client contains a plurality of components such as a processor, chip set, peripheral devices (e.g., a hard drive, floppy drive, key board, mouse, etc.), etc. that are all subject to malfunction. When one or more of these components malfunction, the client may cease to function properly and may need to be rebooted.

Current client/server systems may use a watchdog timer to monitor system operation. In some cases, the watch dog timer may reset or re-boot the computer in the case of a fault.

### BRIEF DESCRIPTION OF THE DRAWINGS

FIG. 1 is a block diagram of a partial computer network in accordance with an embodiment of the present invention.

FIG. 2 is a flowchart illustrating the operation of a multi-stage watch-dog timer in accordance with embodiments of the present invention.

### DETAILED DESCRIPTION

Embodiments of the present invention provide a multi-stage watch-dog timer and a system management controller for system manageability and fault detection in a computer system. Embodiments of the invention provide a multilevel detection and monitoring system for computers. Embodiments of the invention may provide fault logging, performance monitoring and graceful exit from a fault state to an operational state.

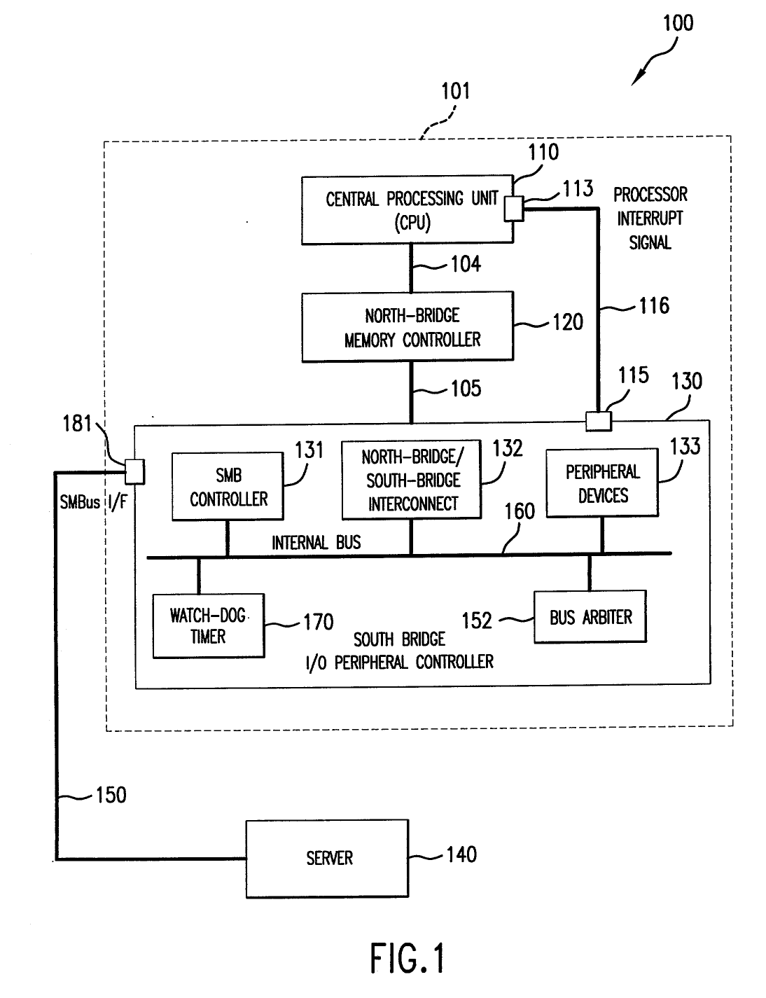

FIG. 1 is a partial block diagram of a system 100 in which the embodiments of the present invention find application.

As shown in FIG. 1, the system 100 is a partial representation of client computer 101 that is coupled to a server 140 via a communication path, for example, a system management bus interface (e.g., SMBUS I/F) 181 using an external system management bus (SMBus) 150.

It is recognized that any other interface and/or bus may be used to couple server 140 with client computer 101. Although only server 140 and client 101 are shown in FIG. 1, it is recognized that additional client computers and/or servers may be included in network 100 and benefit from embodiments of the present invention. In embodiments of the present invention, server 140 maybe an external micro-controller that may reside on or external to the motherboard of the client computer 101. In which case the micro-controller 140 maybe may be coupled to another console external to the computer 101.

Additionally, it is recognized that the devices such as server 140 and/or client 101 may be coupled to each other using a wireless interface and/or a wireless communications protocol. Embodiments of the present invention may find application in a personal digital assistant (PDA), a laptop, a cell phone, and/or any other handheld and/or desktop device.

In embodiments of the present invention, client computer 101 may include a CPU 110 connected to the South-bridge I/O peripheral controller 130 via the North-bridge memory controller 120. The CPU 110 may be coupled to the controller 120 using, for example, a host bus 104 and the North-bridge controller 120 may be coupled to the South-bridge controller 130 using bus 105. Typically, the North-bridge controller 120 connects the CPU 110 to main/secondary memory, graphics controller(s), and the peripheral component interconnect bus (PCI bus). The South-bridge controller 130 may connect all the other I/O devices to the PCI bus 105. The I/O devices may be indirectly connected to the CPU 110 via the PCI bus and the Host-PCI bus 104 on the North-bridge controller 120.

As indicated above, the server 140 may be coupled to the South-bridge controller 130 via the interface 181 using external SMBus 150 and/or other external interface/bus combination.

In embodiments of the present invention, CPU 110 may include a processor interrupt input 113 that may receive a processor interrupt signal via line 116 from processor interrupt output 115 generated by the South-bridge controller 130.

In embodiments of the present invention, the South-bridge controller 130 may include, for example, a system management bus (SMB) controller 131, a multi stage watch-dog timer 170, a North-bridge/South-bridge interconnect 132, peripheral devices 133, bus arbiter 152 coupled to each other using internal bus 160. The internal bus 160 may be, for example, an ISA bus, a SMBus, a PCI bus and/or any other type of bus. The South-bridge controller 130 may include additional components, for example, an internal PCI bridge-1, internal PCI bridge-2, an external PCI interface, a system management bus host (SMBus host), internal PCI bridge configuration registers, low pin count (LPC) registers, etc. (not shown). The internal PCI bridge-1 may couple these components to the internal bus 160. Further, these components may be coupled to each other using, for example, a PCI bus or other bus types.

In embodiments of the present invention, the SMB controller 131 and/or watch-dog timer 170 may help to manage the operation of network 100. An embodiment of the invention may provide a multilevel detection and monitoring system for the plurality of components located within or external to client 101. Although the multi-stage watch-dog timer 170 and/or SMB controller 131 are shown within the South-bridge controller 130, it is recognized that these devices can be located external to the South-bridge controller 130. For example, the watch-dog timer 170 and/or the SMB controller 131 may be located in server 140. In this case, these devices may be connected to the client computer 101 using, for example, an SMBus with an external SMBus interface or an internal PCI bus using an external PCI interface. Accordingly, each computer in the network 100 may be equipped with an internal SMB controller and/or watchdog timer or, alternatively, an external SMB controller and/or watchdog timer may be used to monitor more than one computer.

In embodiments of the present invention, system 100 may include additional computers, modules and/or devices that are not shown for convenience. The network 100 may be a local-area network (LAN), a wide-area network (WAN), a campus-area network (CAN), a metropolitan-area network (MAN), a home-area network, an Intranet, Internet and/or any other type of computer network. It is recognized that embodiments of the present invention can be applicable to two computers that are coupled together in, for example, a client-server relationship or any other type of architecture such as peer-to-peer network architecture. The network 100 may be configured in any known topology such as a bus, star, ring, etc. It is further recognized that network 100 may use any known protocol such as Ethernet, fast Ethernet, etc. for communications.

In embodiments of the present invention, client 101 includes a plurality of internal and/or external communication buses that connect the various components internal to and/or external to the client 101. These busses may include, for example, host bus 104, PCI or proprietary bus 105, internal bus 160, SMBus 150 and/or other PCI buses (not shown).

In embodiments of the invention, the bus arbiter 152 may control access to internal bus 160. The bus arbiter 152 may contain logic to arbitrate between traffic and/or requests from the plurality of devices connected to internal bus 160. Typically, if the internal bus 160 is being accessed by another device such as CPU 110, the bus arbiter 152 will likely not grant access to another device such as the SMB controller 131. When the internal bus 160 is available, SMB controller 131 may be granted access to the internal bus 160. In one example, the SMB controller 131 may place a command and/or data on the internal bus 160. The command may be received by the device and/or component identified by an address included in the command. Once the device and/or component processes the command, data may be returned to the SMB controller 131 when the internal bus 160 is available.

As indicated above, the server 140 may be coupled to the SMB controller 131 via interface 181 using external SMBus 150. The SMB controller 131, watch-dog timer 170, CPU 110, and other devices connected to the internal bus 160 may request access to the bus 160 from bus arbiter 152. For example, CPU 110 may request access to internal bus 160 from arbiter 152 to start and/or periodically re-start the watch-dog timer 170. In another example, watch-dog timer 170 may request access to bus 160 from arbiter 152 to send a processor interrupt signal via line 116 to CPU 110 and/or information related to a fault on the computer to system management controller 131. The processor interrupt signal 116 may be sent to the CPU 110 using the processor interrupt output 115.

In embodiments of the present invention, the watch-dog timer 170 may contain a multi-stage timer that may be used to monitor the operation of, for example, components external to and/or components internal to client computer 101. The multi-stage timer may include two, three, or more stages. Components external to the client may include peripheral devices 133 that may be, for example, a hard drive, floppy drive, keyboard, mouse, etc. In embodiments of the present invention, the SMB controller 131 may read the contents of registers related to the peripheral devices 133. Additionally, the SMB controller 131 may also read the contents of the internal PCI Bridge configuration registers, LPC registers and/or other information associated with components included in the client computer 101.

In embodiments of the present invention, each stage of the multi-stage watch-dog timer maybe, for example, a 8, 16 bit ripple counter that counts up to a pre-determined terminal count. The watch-dog timer 170 may be used to monitor hardware and/or software operation executed in the computer network 100. In the event of a fault such as a runaway software process executed by client 101, the client computer 101 may be re-booted and/or the SMB controller 131 may log information related to the fault.

It is recognized that each stage of the watch-dog timer may include a timer independent from the other stages. In other words, the multi-stage timer may include, for example, three independent timers that can be set, started, re-started and/or re-set independent of each other. Each stage of the timer may count up to a pre-determined terminal count. Once the predetermined terminal count is reached, the watch-dog timer 170 may, for example, cause a processor interrupt signal 116 to be sent to processor 110 and/or may cause fault related information to be sent to the SMB controller 131. Typically, the term “re-start” as used herein may mean that the timer is set to zero and begins recounting automatically. The term “re-set” as used herein may typically mean that the timer may be set to zero but may not start re-counting until actually started by another device and/or action. These terms may be used interchangeably when appropriate.

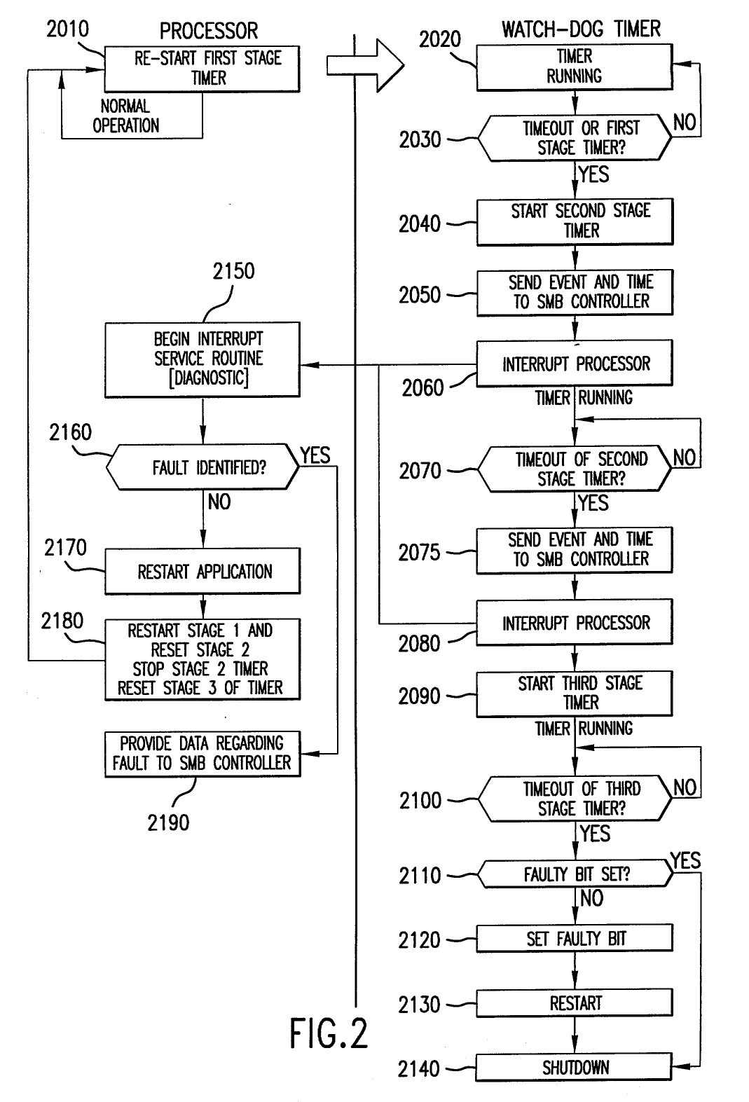

FIG. 2 is a flowchart illustrating the operation of a multi-stage watch-dog timer in accordance with an embodiment of the present invention. Under normal operating conditions, the processor 110 may start a first stage of the multi-stage watch-dog timer 170 and re-start it periodically, as shown in 2010.

In one embodiment, the processor 110 may send a request to arbiter 152 for access to internal bus 160. When access to the internal bus 160 is granted, the processor 110 may send a start command to the timer 170 to begin counting on the first stage of the watch-dog timer 170. In response, the watch-dog timer 170 starts counting up to a first pre-determined terminal count.

In embodiments of the present invention, if the computer network 100 is operating without any system faults or errors, the processor 110 will periodically re-start the watch-dog timer 170 before the first stage of the timer times out. In other words, under normal operating conditions, the processor 110 re-start the first-stage of the multistage watch-dog timer before the first pre-determined terminal count is reached. Once the timer 170 has been re-started, the first stage of the timer begins re-counting towards the first pre-determined terminal count, as shown in 2020.

In embodiments of the present invention, the processor 110 may re-start and/or re-set, each of the multi-stages of the watch-dog timer counters at periodic intervals. These periodic intervals may be set based on, for example, system design and/or system requirements. These periodic intervals may be, for example, anywhere from hundred (100) micro-seconds to five (5) seconds. It is recognized that in embodiments of the present invention, the periodic intervals may be less than 100 micro-seconds and/or more than five (5) seconds.

In embodiments of the present invention, the application running on the computer system may re-start the watch-dog timer at a set interval that may be a smaller interval than the timeout interval. The application may use an interrupt to trigger the re-start routine for the watch-dog timer. A real time clock circuit or timer circuit may generate the interrupt for the desired interval.

If the first stage of the watch-dog timer 170 times out, the second stage of the watch-dog timer 170 is started, as shown in 2030-2040. The second stage of the watch-dog timer may be started by the timeout of the first stage of the watch-dog timer. Logic in the timer hardware, SMB controller and/or the computer system may provide this automatic start sequence of the different timer stages. In embodiments of the present invention, the processor 110 may fail to re-start the timer 170 before it reaches a pre-determined terminal count because of, for example, a computer system malfunction or fault. Examples of such faults may be, a stuck processor or peripheral, or a processor that is executing runaway code, or other types of faults that cause the operating system or computer system lockup or malfunction. Hardware and/or Software faults may prevent the processors from re-starting the timers.

In embodiments of the present invention, in a normally functioning computer system, once the watchdog timer is started, it may run until the next re-set or power off. A fault on the computer system may affect the re-setting and/or re-starting of the watch-dog timer. Depending on the severity of the fault, different stages of the watch-dog timer may timeout.

In embodiments of the present invention, if the first stage of the watch dog timer times out, a “check system” signal may be sent to the SMB controller 131, as shown in 2050. The “check system” signal may identify the type and/or time of the fault or event. The SMB controller 131 may log the fault type and/or time and send this information to a server 140 for system management. In embodiments of the present invention, the watch-dog timer 170 and/or SMB controller 131 may send a first processor interrupt signal to the processor 110, as shown in 2060. As described above, the interrupt signal may be sent to the processor 110 using, for example, interrupt output 115, line 116 and/or interrupt input 113. It is recognized that these processes can occur in any order.

In embodiments of the present invention, as the second stage of the watch-dog timer 170 advances towards a second pre-determined terminal count, the processor 110 may start an interrupt service routine in response to the first interrupt signal generated by watch-dog timer 170, as shown in 2150. As part of the interrupt service routine, the processor 110 may run a diagnostic test to identify the system fault. As indicated above, the fault may be a hardware and/or software fault. In embodiments of the present invention, if the fault is identified during the diagnostic test, the processor 110 may send the diagnostic information to the SMB controller 131 for storage, as shown in 2160 and 2190. In addition, the SMB controller 131 may forward the diagnostic information to the server 140.

In embodiments of the present invention, if the processor 110 is unable to identify the fault, the application that is currently running may be re-started, as shown in 2170. For example, any program and/or routine, the processor 110 was running when the system fault occurred, may be re-started.

In embodiments of the present invention, if the processor 110 discovers a fault that can be identified and/or corrected by re-starting the application, the second stage of the watch-dog timer 170 may be re-set before timing out or reaching the second predetermined terminal count. In this case, the first stage of the watch-dog timer 170 may be re-started and the second stage of the watch-dog timer may suspend counting, as shown in 2180. The second stage of the watch-dog timer may resume recounting once it is re-started if the first stage of the watch-dog timer time outs.

In embodiments of the present invention, if the second stage of the watch-dog timer 170 times out, the third stage of the watch-dog timer 170 is started, as shown in 2090. The watch-dog timer 170 may be started by, for example, the processor 110 or the SMB controller 131. In this case, the failure to re-set the second stage of the watch-dog timer before it times out may indicate that severe fault on the computer system has occurred. In addition to the hardware and/or software faults described above, examples of severe faults may be hardware faults such as a disconnected wire and/or connector, a malfunctioning peripheral, etc. The third stage of the watch-dog timer may be started by the timeout of the second stage of the watch-dog timer. As indicated above, logic in the timer hardware, SMB controller and/or the computer system may provide this automatic start sequence of the different timer stages.

In embodiments of the present invention, responsive to the timeout of the second stage, the watch-dog timer 170 may send a second processor interrupt signal to the processor 110, as shown in 2080. As shown in 2075, the watch-dog timer 170 may also sends another “check system” signal to the SMB controller 131. The second “check system” signal may identify the event type and/or time of the fault. The SMB controller 131 may log this information in memory, and send the information related to the fault to the server 140 for system management. It is recognized that these processes can occur in any order.

In embodiments of the present invention, as the third stage of the watch-dog timer 170 advances towards a third pre-determined terminal count, the processor 110 may begin another interrupt service routine in response to the second processor interrupt generated by the watch-dog timer 170. In embodiments of the present invention, the second processor interrupt received by the processor using interrupt 113 may be a system management interrupt or a non-maskable high priority interrupt. As part of the interrupt service routine, the processor 110 may run a diagnostic test to identify the system fault identified by the second check system signal, as shown in 2150.

In embodiments of the present invention, if the fault is identified during the diagnostic test, the processor 110 may send the diagnostic information to the SMB controller 131 for storage, as shown in 2160 and 2190. The SMB controller 131 may forward the diagnostic information to the server 140. If the fault is identified, computer system 101 and/or the application may be re-started, as shown in 2170. In this case, the third stage of the watch-dog timer may be re-set, as shown in 2180. The third stage of the watch-dog timer may be re-started by the second stage timeout.

In embodiments of the present invention, if the fault is related to one or more peripheral devices, the peripheral devices may be re-started. In embodiments of the present invention, the devices may be re-started automatically by the computer system and/or manually by a user.

In embodiments of the present invention, if the processor 110 discovers a fault that can be identified and/or corrected by re-starting the computer system and/or the application, the third stage of the watch-dog timer 170 may be re-set before timing out or reaching the third predetermined terminal count. In this case, the first stage of the watch-dog timer 170 may be re-started and the second and third stages of the watch-dog timer may suspend counting, as shown in 2180. The second and third stages of the watch-dog timer may resume recounting once the timers are re-started under processor control.

In embodiments of the present invention, if the third stage of the watch-dog timer 170 times out, the computer system may be re-started, as shown in 2130. The watch-dog timer may send the information related to the fault to the SMB controller 131. The SMB controller 131 may set a “faulty system re-set” bit to indicate that the system was re-set due to a system fault, as shown in 2120. In embodiments of the present invention, the SMB controller 131 may log the fault and related timing information and send a copy of the fault and related fault information to the server 140

In embodiments of the present invention, the faulty system re-set bit may not change states even when the system is re-set. The indication that the faulty system bit was set can be logged in the system controller 131. If the faulty system re-set bit is set more than a pre-determined number of times, for example, one or more times, the SMB controller 131 may power down the entire computer system and notify the server 140 that the computer needs to be serviced by, for example, a service technician, as shown in 2140.

Embodiments of the present invention permit the monitoring of a computer system to ensure proper operation. If problems continue, they are handled in a manner that permits the server to realize the severity of the problem and allow graceful power down of the computer system. In embodiments of the present invention, the server can monitor the operation of one or more clients coupled to the server. If necessary, the server 140 can log information related to system faults and may also output a service request to correct problems associated with each client. Although FIG. 2 and associated text describe a three stage watch-dog timer, it is recognized that embodiments of the present invention may include two, three, four or more stage watch-dog timers.

It is recognized that suitable hardware and/or software may be implemented to configure, for example, the watch-dog timer 170 and the SMB controller 131 in accordance with embodiments of the present invention. Additionally, the server 140, bus arbiter 150, peripheral devices 133, CPU 110, and/or any other component shown in FIG. 1 and/or discussed herein may be configured with the appropriate hardware and/or software in accordance with embodiments of the present invention.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. An apparatus comprising:
a multi-stage watch-dog timer to monitor device operation in a computer system; and
a system bus controller to receive data related to a computer system fault from the multi-stage watch-dog timer, to log the fault data in memory and forward the fault data to an external server.

2. The apparatus of claim 1, further comprising:
a processor to re-set the multi-stage watch-dog timer at pre-determined intervals during normal operation.

3. The apparatus of claim 1, further comprising:
a processor to receive an interrupt from the watch-dog timer if at least one stage of the multi-stage watch-dog timer is not re-set during the fault and the processor to further run a diagnostic test to find the fault.

4. The apparatus of claim 1, wherein the multi-stage watch-dog timer includes three stages.

5. The apparatus of claim 1, wherein the multi-stage watch-dog timer includes more than three stages.

6. A method comprising:
during normal operation of a processor, periodically re-starting a first stage of a multi-stage watch-dog timer;
if the first stage of the watch-dog timer times out,
starting a second stage of the multi-stage watch-dog timer;
sending a first interrupt to the processor; and
sending a first signal to a system management controller to log data related to a fault on the computer; and
if the second stage of the watch-dog timer times out before the second stage is re-set by the processor,
starting a third stage of the watch-dog timer;
sending a second interrupt to the processor; and
sending a second signal to the system management controller to log data related to the fault on a computer; and
if the third stage of the watch-dog timer times out before it is re-set by the processor,
re-starting the computer.

7. The method of claim 6, further comprising:
sending the data related to the fault on the computer to an external server.

8. The method of claim 6, further comprising:
receiving the first interrupt at the processor; and
responsive to the first interrupt, starting a diagnostic routine to diagnose the fault on the computer.

9. The method of claim 8, further comprising:
sending diagnostic information to the system management controller if the diagnostic routine diagnoses the fault.

10. The method of claim 9, further comprising:
sending the diagnostic information to an external server.

11. The method of claim 7, further comprising:
re-starting an application if the if the diagnostic routine does not diagnose the fault on the computer.

12. The method of claim 6, further comprising:
re-starting the first stage of the watch-dog timer based on a pre-determined interval before a first pre-determined terminal count is reached.

13. The method of claim 6, further comprising:
re-setting the second stage of the watch-dog timer if the fault is identified.

14. The method of claim 6, further comprising:
re-setting the third stage of the watch-dog timer if the fault is identified.

15. The method of claim 6, further comprising:
receiving the second interrupt at the processor; and
responsive to the second interrupt, starting a diagnostic routine to diagnose the fault on the computer.

16. The method of claim 15, further comprising:
sending diagnostic information to the system management controller if the diagnostic routine diagnoses the fault on the computer.

17. The method of claim 6, further comprising:
setting a faulty system bit if the third stage of the watch-dog timer reaches a third predetermined terminal count before the third stage is re-set by the processor.

18. The method of claim 6, further comprising:
setting a faulty system bit if the third stage of the watch-dog timer times out.

19. The method of claim 18, further comprising:
determining if the faulty bit was set earlier; and
if the faulty bit was set earlier, initiating a computer shutdown.

20. A machine-readable medium having stored thereon a plurality of executable instructions, the plurality of instructions comprising instructions to:
re-start a first stage of a multi-stage watch-dog timer;
if the first stage of the watch-dog timer times out before the first-stage is re-started by a processor,
start a second stage of the multi-stage watch-dog timer;
send a first interrupt to the processor; and
send a first signal to a system management controller to log data related to a fault on the computer; and
if the second stage of the watch-dog timer times out before the second stage is re-set by the processor,
start a third stage of the watch-dog timer;
send a second interrupt to the processor; and
send a second signal to the system management controller to log data related to the fault on a computer; and
re-start the computer, if the third stage of the watch-dog timer times out before it is re-set by the processor.

21. The machine-readable medium of claim 20 having stored thereon additional executable instructions, the additional instructions comprising instructions to:
receive the first interrupt at the processor; and
responsive to the first interrupt, start a diagnostic routine to diagnose the fault on the computer.

22. The machine-readable medium of claim 21 having stored thereon additional executable instructions, the additional instructions comprising instructions to:
sending diagnostic information to the system management controller if the diagnostic routine diagnoses the fault.

23. The machine-readable medium of claim 21 having stored thereon additional executable instructions, the additional instructions comprising instructions to:
re-start an application if the if the diagnostic routine does not diagnose the fault on the computer.

24. The machine-readable medium of claim 20 having stored thereon additional executable instructions, the additional instructions comprising instructions to:
re-start the first stage of the watch-dog timer based on a pre-determined interval before a first pre-determined terminal count is reached.

25. The machine-readable medium of claim 20 having stored thereon additional executable instructions, the additional instructions comprising instructions to:
re-set the second stage of the watch-dog timer if the fault is identified.

26. A multi-stage watch dog timer to monitor operations of a computer comprising:
a first stage to count to a first pre-determined terminal count, wherein if the first stage times out, the multi-stage watch dog timer to send event information to a system management controller and to send a first interrupt to a processor;
a second stage to count to a second pre-determined terminal count, wherein if the first stage times out, the second stage is started, and the multi-stage watch dog timer to send event information to the system management controller and send a second interrupt to the processor; and
a third stage to count to a third pre-determined terminal count, wherein if the second stage times out, the third stage is started, and the multi-stage watch dog timer to set a faulty bit if the third stage times out.

27. The multi-stage watch dog timer of claim 26, wherein the watch dog timer to restart the computer if the faulty bit is set.

28. The multi-stage watch dog timer of claim 26, wherein the watch dog timer to determine if the faulty bit was previously set and if so, then the watch dog timer to shut down the computer.

29. A processor management method comprising:
periodically re-starting a first stage of a multi-stage watch dog timer during normal operation;
responsive to received first or second interrupts, beginning an interrupt service routine to diagnose a fault;
restarting an application if the fault is not diagnosed; and
responsive to a third interrupt, re-starting the processor.

30. The method of claim 29, further comprising:
re-setting a third-stage of the multi-stage timer if the third-stage times out.

31. The method of claim 29, further comprising:
providing fault data to a system management controller, if the fault is diagnosed.

32. A system comprising:
a multi-stage watch dog timer to count to predetermined first, second and third terminal counts;
a central processing unit to receive an interrupt if the first and second terminal counts are reached and responsive to the interrupt begin an interrupt service routine to diagnose a fault; and
a system management controller to receive data related to the fault.

33. The system of claim 32, further comprising:
an external micro-controller to receive data related to the fault from the system management controller.

34. The system of claim 32, wherein the watchdog timer to set a faulty bit if the third terminal count is reached.

35. The system of claim 34, wherein the watchdog to restart the computer if the faulty bit is set.

36. The system of claim 34, wherein the watchdog timer to shutdown the computer if a faulty bit is set.
